(19) United States
(12) Patent Application Publication
(10) Pub. No.: US 2004/0094389 A1
(43) Pub. Date: May 20, 2004

(54) Conveyor having carriers with movable jaws

(76) Inventor: Keith W. Boyce, Philadelphia, PA (US)

Correspondence Address: John A. Chionchio, Esquire, Synnestvedt & Lechner LLP, Suite 2600, 1101 Market Street, Philadelphia, PA, 19107-2950, US

(21) Appl. No.: 10/299,556

(22) Filed: Nov. 19, 2002

(51) Int. Cl. B65G 17/32; B65G 17/12

(52) U.S. Cl. 198/377.01; 198/470.1; 198/540; 198/803.3; 198/803.9

(57) ABSTRACT

A carrier for transporting pellet-like objects is disclosed. The carrier has a fixed jaw portion and a movable jaw portion positioned in spaced relation and opposite to the fixed jaw portion. The movable jaw portion is movable between an open and a closed position. When in the closed position, the jaw portions cooperate to grip the pellet-like item. The jaw portions are mounted on a movable conveyor which moves the carriers through a processing station which performs an operation on the pellet-like object while it is gripped by the jaw portions. An actuator extends from the movable jaw portion and is used to actuate the jaw portions into the closed position. A camming surface engages the actuator to close the jaw portions. Parts of the camming surface are sloped so as to gradually close and gradually allow the jaw portions to open.

### FIELD OF THE INVENTION

The invention relates to a carrier having movable jaws for holding pellet-like objects for transport in a machine which processes the pellet-like objects.

### BACKGROUND OF THE INVENTION

In the manufacture of products such as pharmaceuticals and confectionary items comprising pellet-like objects such as pills, capsules, lozenges, tablets and caplets, it is often desired to perform a manufacturing related operation on each object. Such operations may be as simple as inspecting or orienting the objects or as complex as printing or etching trademark or brand name indicia on each object. Mechanical operations, such as drilling holes in the objects, may also be performed as part of the manufacturing process.

For operations such as printing indicia or drilling holes, the accuracy and precision of the operation is strongly affected by how the pellet-like objects are presented to the apparatus effecting the operation. Machines which perform such operations typically have an endless conveyor which passes through a hopper filled with bulk pellet-like objects. The conveyor has carrier bars with pockets shaped to conform to the shape of the objects. Each pocket in the carrier bar receives a pellet-like object as it passes through the hopper. The conveyor moves the carrier bars to a processing station, which may, for example, be a rotogravure printing wheel, a laser printer or a laser drill. As each bar passes the processing station, the desired operation, for example, printing or drilling, is performed on each pellet-like object held on each carrier bar. Upon completion of the operation, the conveyor moves the pellet-like objects onward for further processing.

If the carrier bars do not present the pellet-like objects to the processing station in a consistent position and orientation, then the operation, printing or drilling, for example, will yield inconsistent results among the objects. Printing may be on different portions of each object, the holes may be drilled in different locations on each object and so forth. Such inconsistency is unacceptable for mass produced consumer items. Furthermore, it is often the case that the operation itself will affect the position and orientation of the pellet-like object on the carrier bar. Thus, even if the carrier bars present each object to the apparatus consistently in the same position and orientation, the actions of the apparatus may cause the object to be displaced or reoriented during the operation, adversely affecting the results of the operation. For example, a gravure wheel may move the object upon contact, causing the printing of the indicia to become distorted. Similarly, if an object shifts in position upon being hit by the beam from a laser drill then the hole drilled in the object will not be round but ellipsoidal in shape.

The characteristics which make pockets in carrier bars easy to fill with pellet-like objects also make them relatively poor at consistently positioning and orienting the objects. For easy filling, the pocket may be oversized, for example, allowing the object to be located anywhere among a range of positions within the pocket. Oversized pockets moreover cannot effectively prevent the pellet-like object from shifting in position within the pocket during processing. There is clearly a need for a carrier mountable on a conveyor which positions and orients pellet-like objects consistently and holds the objects firmly during manufacturing operations so that operations such as printing or drilling may be performed yielding consistent, high-quality results.

### SUMMARY AND OBJECTS OF THE INVENTION

The invention concerns a carrier useable on a movable conveyor for transporting pellet-like objects. The carrier comprises a first jaw portion mountable on the conveyor and having a first surface engageable with the pellet-like object and a second jaw portion mountable on the conveyor in spaced relation to the first jaw portion. The second jaw portion has a second surface substantially facing the first surface and engageable with the pellet-like object. One of the jaw portions is movable toward the other of the jaw portions into a closed position for gripping a pellet-like object between the first and the second surfaces. The one jaw portion is also movable away from the other jaw portion into an open position for releasing the pellet-like object from the carrier. The carrier also includes an actuator for moving the one jaw portion relatively to the other jaw portion between the open and the closed positions at predetermined positions spaced lengthwise along the conveyor.

The invention also concerns a movable conveyor for transporting pellet-like objects along a path. The conveyor comprises a plurality of carriers for holding the pellet-like objects, the carriers being positioned one behind another and movable along the path, each of the carriers being substantially as described above.

A method of transporting pellet-like objects along a path is also part of the invention. The method includes the steps of:

(a) providing a carrier movable along the path and having opposing jaw portions engageable with the pellet-like object, the jaw portions being relatively movable toward one another into a closed position for gripping the pellet-like object and biased away from one another into an open position for releasing the pellet-like object;

(b) biasing the jaw portions into the open position and loading the pellet-like object onto the carrier between the jaw portions;

(c) moving the carrier along the path, the path including a portion positioned between predetermined locations spaced lengthwise therealong and traversed by the carrier;

(d) moving the jaw portions into the closed position while the carrier traverses the predetermined portion of the path between the predetermined locations thereby gripping the pellet-like object between the jaw portions; and

(e) biasing the jaw portions into the open position after the carrier has traversed the portion of the path between the predetermined locations, thereby releasing the pellet-like object.

The method may further include the step of performing an operation on the pellet-like object while the carrier is traversing the portion of the path between the predetermined locations where the pellet-like object is securely gripped.

It is an object of the invention to provide a carrier useable with a conveyor for transporting pellet-like objects.

It is another object of the invention to provide a carrier for pellet-like objects which grips the pellet-like objects.

It is still another object of the invention to provide a carrier which grips pellet-like objects and holds them in a consistent position and orientation for performing a processing operation on the pellet-like objects.

It is again another object of the invention to provide a carrier which ensures consistent, high-quality processing of pellet-like objects.

It is yet again another object of the invention to provide a carrier which grips pellet-like objects without damaging them.

It is still another object of the invention to provide a method for processing pellet-like objects consistently and with high quality.

These and other objects of the invention will be apparent upon consideration of the following drawings and detailed description of preferred embodiments of the invention.

### BRIEF DESCRIPTION OF THE DRAWINGS

FIG. 1 is a side view of a machine using carriers according to the invention;

FIG. 2 is a perspective drawing of a carrier according to the invention;

FIG. 3 is an exploded perspective view of the carrier shown in FIG. 2; and

FIG. 4 is a partial sectional view of a portion of the machine shown in FIG. 1.

### DETAILED DESCRIPTION OF PREFERRED EMBODIMENTS

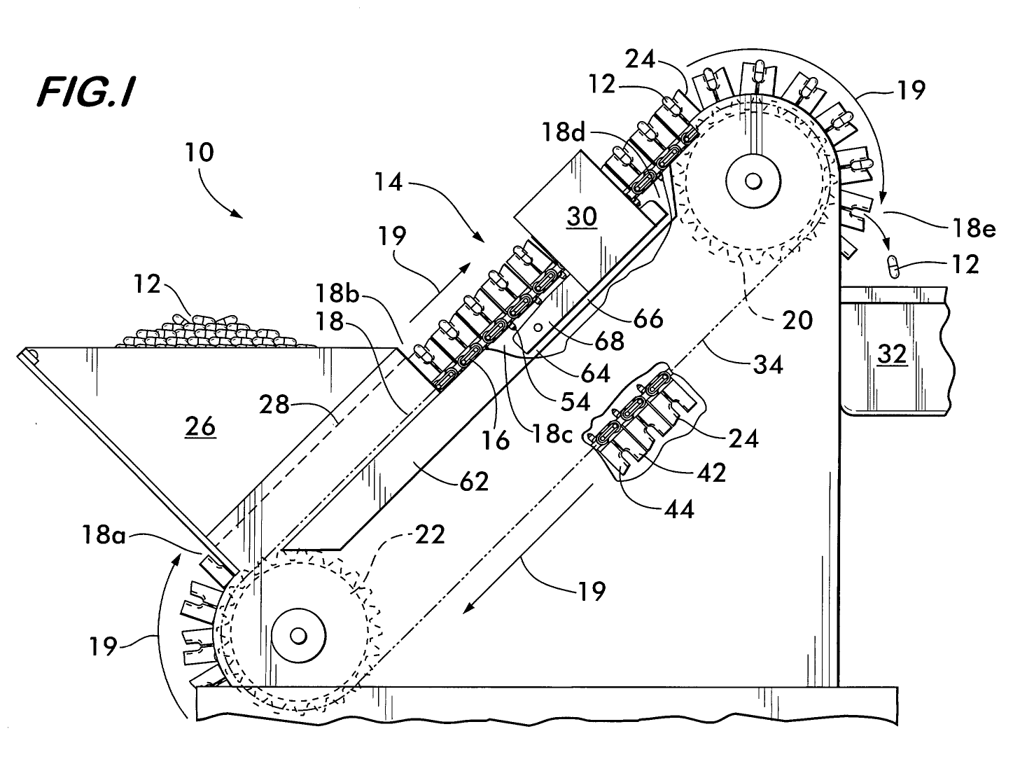

FIG. 1 shows a machine 10 for processing pellet-like objects 12, shown by way of example as elongated capsules. Machine 10 includes a conveyor 14 formed, for example, from an endless chain 16 which is moved along a path 18 in the direction shown by arrows 19 by sprockets 20 and 22. The sprockets 20 and 22 are preferably powered by an electric motor (not shown). A plurality of carriers 24 are mounted on the endless chain 16, preferably one behind the other in the manner of individual articulated links allowing the chain to bend around sprockets 20 and 22. Carriers 24 hold the pellet-like objects 12 and transport them for processing by the machine as described in detail below.

Carriers 24 are conducted along path 18 which begins at point 18a as the carriers enter a hopper 26 positioned over the path 18. Hopper 26 holds pellet-like objects 12 in bulk and preferably has an open bottom 28 which allows the carriers 24 to pass through the hopper 26 as they move along path 18 and receive pellet-like objects 12. Carriers 24 emerge from the hopper 26 at point 18b along path 18 with each carrier holding a pellet-like object 12. The carriers 24 are moved further along path 18 to a processing station 30 mounted on the machine 10 and located along the path 18.

Processing station 30 is shown schematically in FIG. 1 and represents any device which performs a desired operation on each pellet-like object. For example, processing station 30 could be a printer for branding the pellet-like objects with a trademark or brand name, a camera for inspecting the objects as they pass or a laser drill for drilling a hole in each object.

As the pellet-like objects 12 pass through the processing station 30, the carriers 24 are actuated at a point 18c to firmly grip the objects 12 and present them to the station in a consistent position and orientation, without allowing them to move within the carriers 24. By gripping the objects 12, the carriers ensure that the operation performed at the processing station will be performed consistently and accurately for each pellet-like object processed. Details of the structure and operation of carriers 24 are described below.

After passing through the processing station, the pellet-like objects 12 are released from the grip of the carriers 24 at a point 18d along path 18. The pellet-like objects 12 are then deposited into a container 32 at a point 18e along path 18. The carriers 24, being mounted on an endless chain 16, move along a return path 34 which takes them back to the hopper 26 where the cycle begins again.

### Carrier Structure and Operation

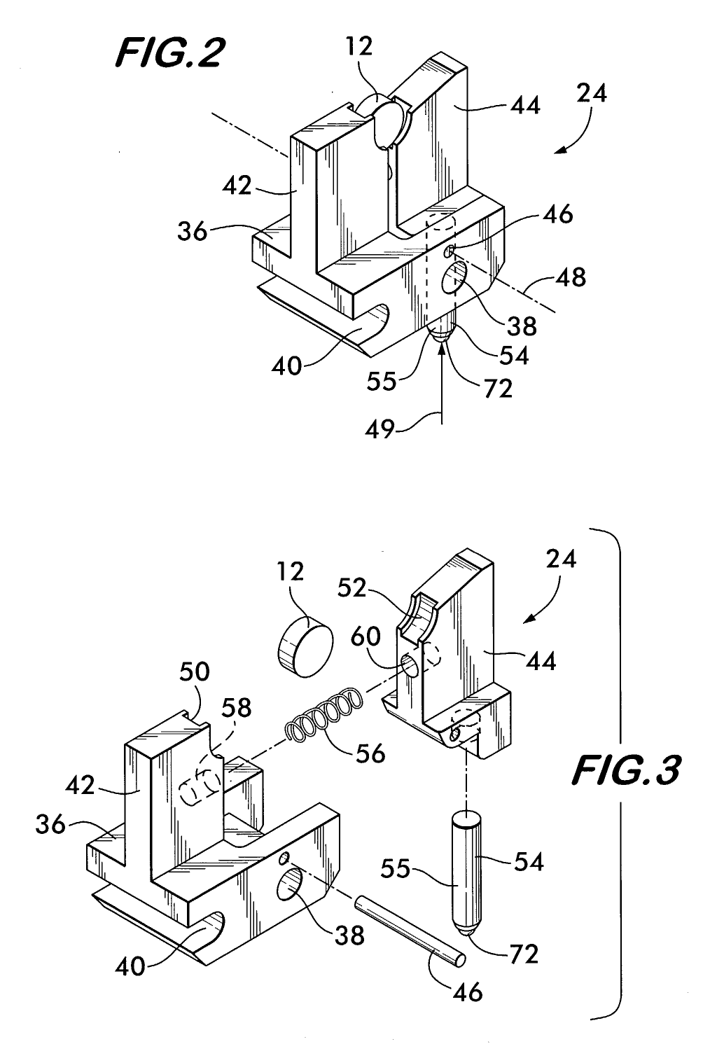

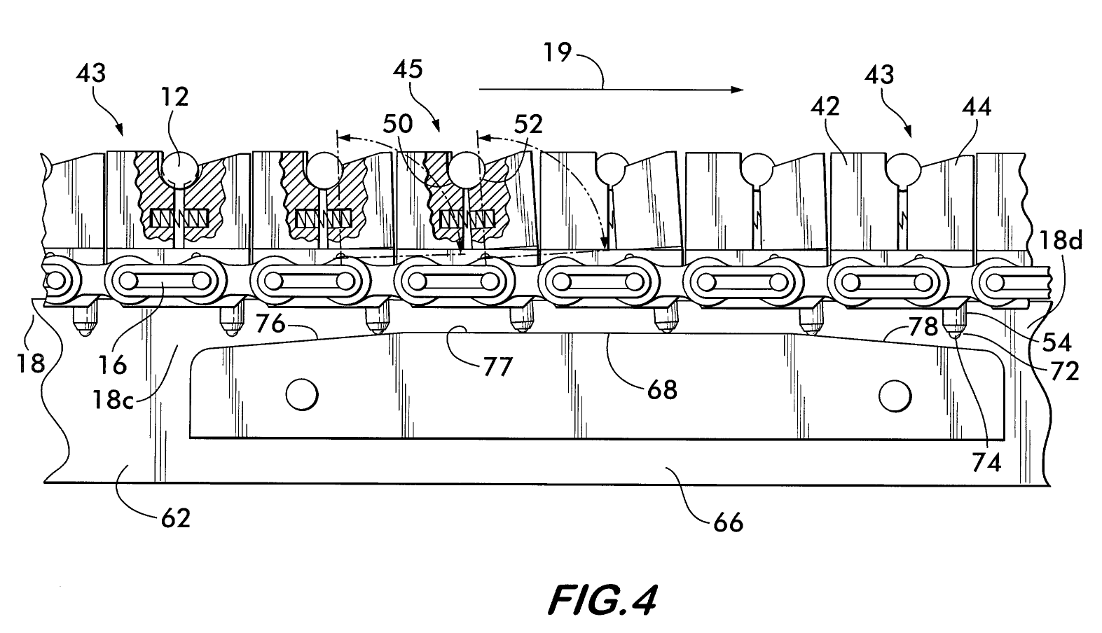

FIGS. 2 and 3 show a carrier 24 in detail. Carrier 24 comprises a base 36 having an aperture 38 and a slot 40 for mounting the carrier 24 on the endless chain 16 comprising conveyor 14 (see FIG. 4). A fixed jaw portion 42 is mounted on the base 36, preferably integrally therewith. The fixed jaw portion 42 preferably projects substantially perpendicularly from the base 36. A movable jaw portion 44 is attached to base 36 in opposition to the fixed jaw portion 42. Preferably, movable jaw portion 44 is pivotally mounted to the base 36 on a pivot pin 46 and is, thus, pivotable about a pivot axis 48 (FIG. 2) oriented substantially perpendicular to the fixed jaw portion 42. Other configurations of movable jaw are also contemplated, such as a jaw portion slidable relatively to the other, and a cantilevered jaw portion which is flexible and resilient and capable of being deflected toward the fixed jaw portion.

Preferably, the movable jaw portion 44 also projects substantially perpendicularly to the base 36. Each jaw portion 42 and 44 has a respective surface 50 and 52 (FIG. 3) which face one another and are engageable with a pellet-like object 12, shown in FIGS. 2-4 by way of example as a round pill. Surfaces 50 and 52 each have a complementary shape which together substantially conform to the shape of the pellet-like object 12, thereby allowing the carrier 24 to receive the pellet-like object as it passes through the hopper 26 of machine 10 as described above with reference to FIG. 1.

Because it is pivotally mounted, the movable jaw portion 44 is pivotally movable relatively to the fixed jaw portion 42 between an open position (identified as 43 in FIG. 4) and a closed position (identified as 45 in the same Figure). In the open position 43, the surfaces 50 and 52 of the fixed jaw portion 42 and the movable jaw portion 44 are separated from one another by a distance which will allow the pellet-like object 12 to easily be received between the surfaces 50 and 52. In the closed position 45, the movable jaw portion 44 is pivoted toward the fixed jaw portion 42 so that the surfaces-50 and 52 grip the pellet-like object 12 and hold it firmly in a desired position and orientation for presentation to the processing station 30 shown in FIG. 1. The gripping action of the carrier 24 ensures that the pellet-like objects 12 are processed consistently and accurately.

As shown in FIGS. 2 and 3, movable jaw portion 44 of the carrier 24 has an actuator 54 for moving movable jaw portion 44 relatively to the fixed jaw portion 42. Preferably, the actuator is in the form of a projection 55 mounted on the movable jaw portion 44 and oriented to extend downwardly, substantially perpendicular to the base 36. A force applied to the actuator 54 in the direction indicated by arrow 49 perpendicular to and spaced from pivot axis 48 will cause the movable jaw portion 44 to pivot relatively to the fixed jaw portion 42 between the open and closed positions.

It is preferred to bias the movable jaw portion 44 into the open position by the use of a coil spring 56 positioned between the jaw portions as shown in FIG. 3. Spring 56 is mounted in sockets 58 and 60 in both jaw portions 42 and 44 and acts as a compression spring to normally bias the jaw portions away from one another.

FIGS. 1 and 4 illustrate how the carriers 24 are actuated to grip the pellet-like objects 12 as they are transported by the conveyor 14 through the processing station 30. Chains 16 of the conveyor move between guide rails 62 and 64 (only one of which is shown in FIG. 4) mounted on each side of machine 10. The guide rails 62 and 64 are arranged in a parallel, spaced relation and define the path 18 which the chain 16 takes in its motion. For most of the path length, the space between guide rails 62 and 64 is empty of obstructions, but along a portion 66 of the path 18, preferably starting at about predetermined position 18c (before processing station 30) and ending at about predetermined position 18d (after the processing station 30), a camming surface 68 is located between the guide rails 62 and 64.

As the carriers 24 traverse the path 18 where there are no obstructions between the guide rails 62 and 64, the jaws 42 and 44 are biased into the open position by the spring 56. This is desired, for example, as the carriers 24 pass through the hopper 26 because the open position allows the carriers to easily acquire pellet-like objects 12 between the opposing surfaces 50 and 52. The open position is also desired after processing (point 18e along path 18) so that the pellet-like objects may be released into the container 32. However, as the carriers 24 carrying pellet-like objects 12 traverse the portion 66 of path 18 between the predetermined positions 18c and 18d (which is substantially co-located with the processing station 30), they encounter the camming surface 68 positioned between the guide rails 62 and 64 as shown in FIG. 4. Camming surface 68 is positioned beneath the carriers 24 such that it is engaged by actuators 54 which preferably extend downwardly from the movable jaw portions 44 of each carrier. Upon engagement, the camming surface 68 applies an upward force to each actuator 54 as each carrier 24 traverses the portion 66 of path 18. The force causes the movable jaw 44 on each carrier to pivot into the closed position 45 and firmly grip the pellet-like object 12 between the surfaces 50 and 52. As long as the actuator 54 engages the camming surface 68 the jaws 42 and 44 will remain in the closed position. Thus, the camming surface 68 is co-located with the processing station 30 between the predetermined positions 18c and 18d so that the pellet-like objects 12 are securely held during processing. Camming surface 68 is sized in length so that each pellet-like object 12 is gripped before and during the processing step and released only after processing is completed.

The camming surface 68 is preferably engaged by the tips 72 of the actuators 54, the actuators being partially hollow and each having a spring biased ball bearing 74 at the tip 72 to facilitate engagement with the camming surface 68 and reduce friction due to the relative motion.

Camming surface 68 preferably comprises a lead-in surface 76 located so as to initially engage the actuators 54 as they pass the predetermined position 18c. The lead-in surface 76 is sloped toward the path 18 as shown in FIG. 4. This enables the actuators 54 to engage the camming surface 68 gradually in order to gradually pivot the movable jaw portion 44 into the closed position 45 and grip the pellet-like object 12 gently, avoiding a harsh impact which might damage it. The lead-in surface 76 also helps mitigate wear of the actuators and camming surface by avoiding a sudden impact of actuator against camming surface.

Camming surface 68 further includes an intermediate surface 77 positioned so as to engage the actuators 54 after the lead-in surface 76. The intermediate surface 77 is oriented substantially parallel to the path 18 for maintaining constant engagement with the actuators 54 and thereby maintaining the movable jaw portion 44 in the closed position 45 to grip and hold the pellet-like objects 12 while the carriers 24 traverse the intermediate surface 77. It is most advantageous to perform any processing operations on pellet-like objects 12 while they traverse the intermediate surface 77 because this is where they are held most securely. Preferably, therefore, the processing station 30 is substantially co-located with the intermediate surface 77.

Camming surface 68 also includes a lead-out surface 78 positioned so as to engage the actuators 54 after the intermediate surface 77. The lead-out surface 78 allows the actuators 54 to disengage from the camming surface gradually, preventing the movable jaw portion 44 from snapping open abruptly under the biasing action of spring 56 and possibly catapulting the pellet-like objects 12 from the carriers 24. The movable jaw portion 44 is biased into the open position 43 upon passing the predetermined position 18d along path 18. This enables the pellet-like object 12 to be released from the carrier, for example, at position 18e and be deposited into the container 32.

Gripping the pellet-like objects 12 during processing ensures that every one of them will be presented to the processing station in the same relative position and orientation, thus, providing for consistent and accurate processing of each pellet-like object and ensuring a high quality product with fewer rejects and less wastage.

What is claimed is:

1. A carrier useable on a movable conveyor for transporting pellet-like objects, said carrier comprising:
a first jaw portion mountable on the conveyor and having a first surface engageable with the pellet-like object;
a second jaw portion mountable on the conveyor in spaced relation to said first jaw portion, said second jaw portion having a second surface substantially facing said first surface and engageable with the pellet-like object, one of said jaw portions being movable toward the other of said jaw portions into a closed position for gripping the pellet-like object between said first and said second surfaces, said one jaw portion also being movable away from said other jaw portion into an open position for releasing said pellet-like object therefrom; and
an actuator for moving said one of said jaw portions relatively to said other jaw portion between said open and said closed positions at predetermined positions spaced lengthwise of the conveyor.

2. A carrier according to claim 1, wherein said first and second surfaces have complementary shapes which together substantially conform to a shape of the pellet-like object.

3. A carrier according to claim 1, wherein said other jaw portion further comprises a base integral therewith and mountable on the conveyor, and wherein said one of said jaw portions is movably mounted on said base for said movement toward and away from said other jaw portion.

4. A carrier according to claim 3, wherein said jaw portions each project substantially perpendicularly to said base.

5. A carrier according to claim 4, wherein said facing first and second surfaces are positioned on said first and second jaw portions in spaced relation to said base.

6. A carrier according to claim 4, wherein said one of said jaw portions is pivotally mounted on said base, said one of said jaw portions being pivotable for pivotally moving said first and second surfaces toward and away from one another for engaging and releasing the pellet-like object.

7. A carrier according to claim 6, wherein said actuator comprises a projection mounted on said one of said jaw portions and extending outwardly therefrom.

8. A carrier according to claim 7, further comprising a camming surface mounted adjacent to said conveyor for engagement of said projection upon relative movement between the conveyor and said camming surface, said camming surface being positioned between said predetermined positions spaced lengthwise of the conveyor, said one of said jaw portions being moved into said closed position toward said other jaw portion while said projection engages said camming surface.

9. A carrier according to claim 8, further comprising a biasing spring engaging said one of said jaw portions and biasing said one of said jaw portions away from said other jaw portion into said open position to release the pellet-like object from said carrier when said projection is out of engagement with said camming surface.

10. A carrier according to claim 9, wherein said biasing spring comprises a coil spring mounted between and engaging said first and second jaw portions in spaced relation to said base.

11. A movable conveyor for transporting pellet-like objects along a path, said conveyor comprising:
a plurality of carriers for holding the pellet-like objects, said carriers being positioned one behind another and movable along the path, each of said carriers comprising:
a first jaw portion having a first surface engageable with a pellet-like object;
a second jaw portion positioned in spaced relation to said first jaw portion, said second jaw portion having a second surface substantially facing said first surface and engageable with the pellet-like object, one of said jaw portions being movable toward the other of said jaw portions into a closed position for gripping the pellet-like object between said first and said second surfaces, said one of said jaw portions also being movable away from the other jaw portion into an open position for releasing the pellet-like object therefrom; and
an actuator for moving said one of said jaw portions relatively to said other jaw portion upon movement of the conveyor along the path through predetermined positions spaced lengthwise therealong.

12. A conveyor according to claim 11, wherein said actuator comprises a projection mounted on said one of said jaw portions and extending outwardly therefrom.

13. A conveyor according to claim 12, wherein said actuator further comprises:
a camming surface positioned adjacent to the conveyor and extending along a portion of the path between said predetermined positions, said carriers moving adjacent to said camming surface while traversing said portion of the path; and
said projections on said carriers being positioned to engage said camming surface while said carriers traverse said portion of the path between said predetermined positions to move said one of said jaw portions toward said other jaw portion into said closed position for gripping said pellet-like objects between said first and said second surfaces.

14. A conveyor according to claim 13, wherein said camming surface comprises a lead-in surface oriented at an angle relatively to the path, said lead-in surface being positioned along the path to initially engage said projections, said lead-in surface sloping toward the path so as to gradually engage said projections and gradually move said one of said jaw portions toward the other jaw portion and into said closed position on each of said carriers to gradually grip the pellet-like objects.

15. A conveyor according to claim 14, wherein said camming surface further comprises an intermediate surface positioned so as to engage said projections after said lead-in surface, said intermediate surface being oriented substantially parallel to the path for maintaining engagement with said projections and thereby maintaining said one jaw portion in said closed position to grip and hold the pellet-like objects while said carriers traverse said intermediate surface.

16. A conveyor according to claim 15, wherein said camming surface further comprises a lead-out surface oriented at an angle relatively to the path, said lead-out surface being positioned along the path to engage said projections after said intermediate surface, said lead-out surface sloping away from the path so as to gradually disengage from said projections and allow said one of said jaw portions to gradually move away from said other jaw portion and into said open position on each of said carriers to gradually release the pellet-like objects.

17. A conveyor according to claim 16, further comprising a biasing spring engaging said one jaw portion and biasing said one jaw portion away from said other jaw portion to release the pellet-like object from said carrier, said one of said jaw portions being biased away from said other jaw portion by said biasing spring when said projection is not engaging said camming surface.

18. A conveyor according to claim 7, further comprising a processing station positioned adjacent to said portion of the path between said predetermined positions, said processing station being adapted to perform an operation on the pellet-like objects while the pellet-like objects are gripped between said jaw portions of said carriers.

19. A conveyor according to claim 18, wherein said processing station comprises a laser drill for drilling a hole in each of the pellet-like objects.

20. A conveyor according to claim 17, wherein said other jaw portion further comprises a base integral therewith and mountable on the conveyor, and wherein said one jaw portion is movably mounted on said base for said movement toward and away from said other jaw portion.

21. A conveyor according to claim 20, wherein said jaw portions each project substantially perpendicularly to said base.

22. A conveyor according to claim 21, wherein said one jaw portion is pivotally mounted on said base, said one jaw portion being pivotable for pivotally moving said first and second surfaces toward and away from one another for engaging and releasing said pellet-like object.

23. A method of transporting pellet-like objects along a path, said method comprising the steps of:
providing a carrier movable along the path and having opposing jaw portions engageable with a pellet-like object, said jaw portions being relatively movable toward one another into a closed position for gripping the pellet-like object and biased away from one another into an open position for releasing the pellet-like object;
biasing said jaw portions into said open position;
loading the pellet-like object onto said carrier between said jaw portions;
moving said carrier along said path, said path including a portion positioned between predetermined locations spaced lengthwise therealong and traversed by said carrier;
moving said jaw portions into said closed position while said carrier traverses said predetermined portion of said path between said predetermined locations thereby gripping the pellet-like object between said jaw portions; and
biasing said jaw portions into said open position after said carrier has traversed said portion of said path between said predetermined locations, thereby releasing the pellet-like object.

24. A method according to claim 23, further comprising the step of performing an operation on the pellet-like object while said carrier is traversing said portion of the path between said predetermined locations.
